(19) United States
(12) Patent Application Publication
(10) Pub. No.: US 2005/0089331 A1
(43) Pub. Date: Apr. 28, 2005

(54) Assured connectivity fiber-optic communications link

(76) Inventor: Near Margalit, Westlake Village, CA (US)

Correspondence Address: GARY L. SHAFFER, 901 BANKS PLACE, ALEXANDRIA, VA, 22312, US

(21) Appl. No.: 10/956,339

(22) Filed: Oct. 4, 2004

Related U.S. Application Data
(60) Provisional application No. 60/507,964, filed on Oct. 3, 2003.

(51) Int. Cl. H04B 10/00

(52) U.S. Cl. 398/139

(57) ABSTRACT

Single transceiver modules are provided at each end of a single communication link such that the need for redundant links is reduced or eliminated. Modules of the invention provide full assurance against disruption of communication due to fiber breakdown, and certain forms of equipment failure, such as the failure of a single receiver. Modules of the invention include multiple reception and transmission ports, and can be applied to any communication link, and require that redundant data be sent by two separate transceivers via two separate fibers. Devices and methods are provided which reduce, or eliminate the need for “client side 1+1 protection.”

### RELATED APPLICATIONS

The present application claims priority to U.S. Provisional Application No. 60/507,964, filed Oct. 3, 2003. The cited Application is hereby incorporated by reference in its entirety.

### FIELD OF THE INVENTION

To This invention deals with very high-speed fiber-optic communication, and in particular with assuring continuous performance of such networks in cases of breakdown of the optical fibers.

### BACKGROUND OF THE INVENTION

High-speed Local Area Networks (LANs) provides the channels for data network communication. The overwhelming majority of this communication is handled via fiber-optic cables. These include inter-office network connectivity, communication between switches and terminal equipment, as well as long distance data communication. In communication via fiber-optic cables, lasers are typically used to transmit data onto the optical fibers and fiber-optic receivers are used to receive the data, respectively. To address the needs of network growth and reconfiguration over time, many service equipment providers are adopting standard interfaces to serve this need. A typical such standard interface is the multi-source agreement (MSA) GBIC. The GBIC standard describes a small form-factor, pluggable interface, which houses the fiber-optic active components, and suits many connectivity applications. Several transmitters and receivers, of different properties can be fit into the same form factor and electrical interface. Such fiber-optic transmitters range from the simple fabry-perot laser sources, to International Telecommunication Union (ITU) standardized, highly precise, coarse wavelength division multiplexed (CWDM) laser transmitters. Receivers of varied performance such as PIN photodiode and Avalanche Photo Diode (APD) based fiber-optic receivers, also fit in the same package and interface. When a transmitter and a receiver are combined on a given side of a data link, the combination is called a transceiver. Transceivers also fit in the GBIC standard of interface and mechanical size. The standard however does not deal with the design of the active devices inside the GBIC package.

Optical and data networking equipment manufacturers, service providers, and customers have different quality of service needs for each network, and often for each link within the network. Typically a certain level of quality assurance is warranted on any given data link. Fiber breakdown is a common failure in networks communication. To assure uninterrupted high quality service, service providers, and network administrators use redundant links, such that in the event that the primary link fails, the redundant link takes over. This type of service assurance is referred to as “client side 1+1 protection”. It can be applied to any communication link, but requires that redundant data be sent by two separate transceivers via two separate fibers.

To extend the communication distances, service providers install repeaters or transponders in the lines of communication. Each transponder comprises of at least two transceivers. Transponder failure is a common failure mechanism in networks, wherein a fiber, a transmitter, or a receiver may fail. This is a reason why the concept of pluggable transceivers is popular, as it eases the replacement when transceivers fail.

This invention addresses both aforementioned scenarios by providing a solution wherein a single transceiver module is used on each end of the link. This invention provides full redundancy, and offers full assurance against disruption of communication due to fiber breakdown, and certain forms of equipment failure, specifically a single receiver failure, or an intermediate transceiver, failure.

A communication link is comprised of a transmitter, a transportation medium, and a receiver, as shown in FIG. 1. In high-speed communication links, the transmitter is typically a laser diode, the transportation medium is a fiber-optic cable, and the receiver is a fiber-optic receiver. Also, typically, in redundant communication links, all the components on a link, transmitter, fiber, and receiver are redundant, as shown in FIG. 2. In an alternative method described here, and better understood by referring to FIG. 3, a fiber optic power splitter is placed between a laser diode transmitter, and two fiber-optic cables. The optical power generated by the laser is split in two, and thus the power level on each fiber is reduced by 3 db (decibels) with respect to the power generated by the laser diode transmitter. The data that modulates the laser transmitter output is not affected by the power splitting, and as the result of the splitting, the two fibers carry identical copies of the same data to two separate receivers. This method therefore provides redundant data paths with only a single fiber-optic transmitter, two receivers in every transceiver, and only two transceivers in a fully redundant link.

To reduce the number of components in a system the optical power splitters shown in FIG. 3, may be moved inside the transceiver module as shown in FIG. 4, without any further effects on the system and its redundancy.

In fiber-optic communication, the fiber-optic receivers typically uses a means to detect the presence of optical power at the receiver's optical input port, and an electronic output signal to indicate the presence or absence of such optical power at the receiver's optical port. In the embodiments of redundant fiber-optic links as shown in FIGS. 3, and 4, during normal operation, optical power, and thus the transmitted data is received on both optical receivers in a transceiver module. Since only one data from one receiver needs to be utilized, a selector mechanism is in place to always select the data from one receiver, identified as the primary receiver, and rejecting the data from the other, secondary receiver, provided the primary receiver is receiving ample optical power and recoverable data. If the primary receiver fails to receive optical power, at the proper level to recover data with high level of integrity, the control mechanism automatically switches over to accept data from the secondary receiver. The newly selected receiver at that point becomes the primary receiver, and the receiver on the failing channel, become the secondary receiver. When optical power, and recoverable data, are restored to the secondary receiver, the control mechanism can retain full redundancy, as it can switch back to the secondary receiver, should the other, primary receiver fail.

The fiber-optic receiver is typically comprised of three parts: a photodiode, a transimpedance amplifier, and a limiting post amplifier. Any of the parts in a receiver may fail and cause a receiver failure. In the event that a receiver failure, and not a fiber failure, causes the breakdown in communication, the detection of the presence of optical power alone does not detect a failure of the receiver. It is conceivable that a problem in the post amplifier will cause data not to come out of the receiver, even though optical power is received. Having two receivers, wherein both receive identical copies of the same data, enables a control mechanism to monitor the optical power reception, and the data output on both receivers, and from the combined information, determine which receiver output is to be utilized.

Splitting the optical power generated by a single laser into two separate fibers, reduces the optical power on each fiber by 3 db, or 50%. This may be a disadvantage, as it may limit the usable distance for a fiber-optic link, and decrease the noise immunity of the receiving end. A fully redundant fiber-optic link utilizing only two transceiver modules, is presented in FIG. 5. In this case two fiber-optic transmitters, and two fiber-optic receivers, are housed together in a single module. In this embodiment the control mechanism may include means to select which receiver's data is to be used, and also which transmitter is to be used. Transmission failure may occur because of a fiber breakdown, or a transmitter breakdown. The transmitters are typically equipped with circuitry to monitor their output, and to indicate that the transmitter generates optical power. The monitoring circuit of the transmitter can not detect the breakdown of the fiber. The control mechanism therefore always operates only a single optical transmitter, keeping the other transmitter in a standby mode. If the primary transmitter fails to generate an optical output, the control turns down the primary transmitter, and activates the secondary one.

### BRIEF DESCRIPTION OF THE DRAWINGS

FIG. 1, shows a typical fiber-optic communication link.

FIG. 2, shows a fiber-optic link with redundancy.

FIG. 3, shows a block diagram of a redundant fiber-optic link according to the present invention.

FIG. 4, shows a block diagram of an alternative fully redundant fiber-optic link.

FIG. 5, shows another block diagram of a fully redundant fiber-optic link.

FIG. 6, shows an embodiment of a fully redundant fiber-optic transceiver module.

FIG. 7, shows an embodiment of a fully redundant fiber-optic transceiver module, with receiver failure detection capability.

FIG. 8, shows an embodiment of a fully redundant fiber-optic transceiver module, with a built-in optical power splitter.

FIG. 9, shows an embodiment of a fully redundant fiber-optic transceiver module, with built-in optical power splitter, and with receiver failure detection capability.

FIG. 10, shows an embodiment of a fully redundant fiber-optic transceiver module, with a redundant fiber-optic transmitter, and with receiver failure detection capability.

FIG. 11, Shows fiber connections and optical power flow in a first exemplary case.

FIG. 12, Shows fiber connections and optical power flow in a exemplary second case.

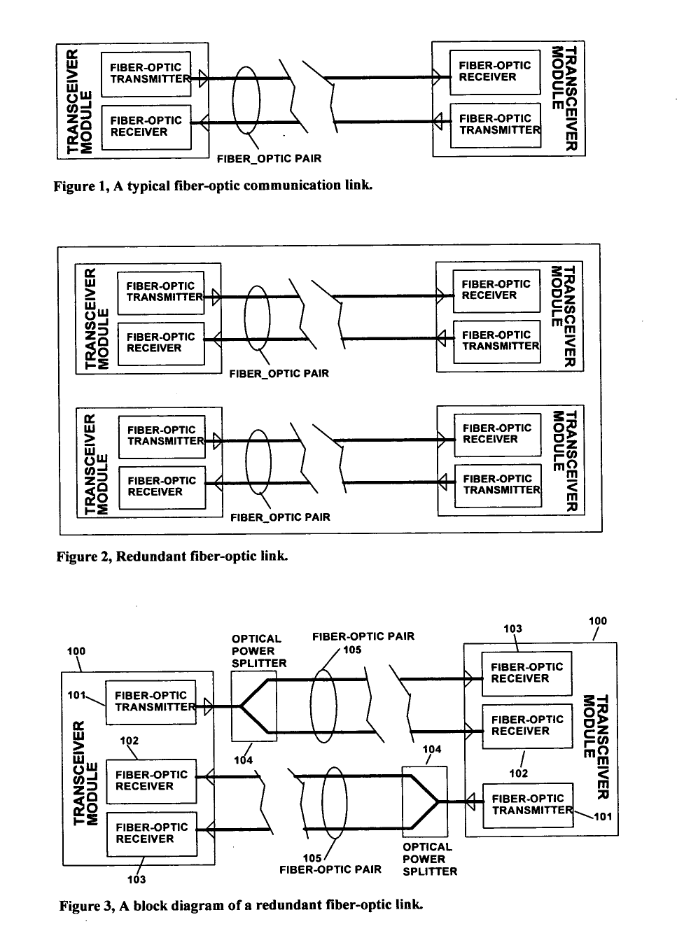

### DETAILED DESCRIPTION OF THE INVENTION

In the following detailed description, reference is made to the accompanying drawings, which form a part of the application, and in which are shown by way of illustration, specific embodiments by and through which the invention may be practiced. The embodiments shown in the drawings include only a few examples of the many embodiments disclosed herein, and are provided in sufficient detail to enable those of ordinary skill in the art, to make and use the invention. As one of skill in the art can appreciate, many structural, logical or procedural changes may be made to the specific embodiments disclosed herein without departing from the spirit and scope of the present invention.

The description of the invention can be best understood referring to FIGS. 3 through 10. FIG. 3, describes one method of achieving full redundancy fiber-optic links, using only two transceiver modules. As shown in FIG. 3, each module (100) is comprised of a fiber-optic transmitter (101), and two fiber-optic receivers (102, 103). An optical power splitter (104), splits the optical power generated by the transmitter, between two fiber-optic cables, each connected on its other end, to a fiber-optic receiver. As a result, two transceiver modules (100) are redundantly interconnected, and in the case of a breakdown in one communication path, there is the other, unaffected path to continue the uninterrupted communication.

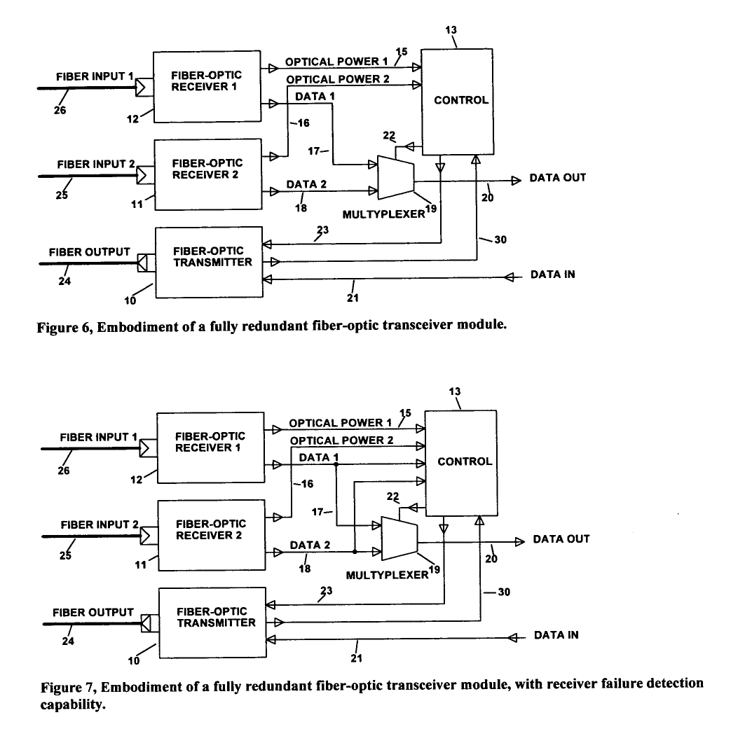

FIG. 6, shows the embodiment of the transceiver (100). Under normal operation conditions, both fiber-optic receivers (11, 12) simultaneously receive identical copies of the same data. Even though both receivers are identical, one is considered as the primary receiver, and the other is the secondary receiver. The determination which receiver is the primary receiver is arbitrary, and is done automatically by the controller (13). The controller monitors the optical power 1 (15), and optical power 2 (16) signals, generated by the fiber-optic receiver 1 (12), and the fiber-optic receiver 2 (11), respectively. Each of these lines, indicates that a sufficient level optical power is being received by the respective receiver, or the lack of optical power. The controller (13) controls the multiplexer (19), to direct data output from one receiver to the transceiver's data output (20). The data output from the receivers (17, 18) is applied to the multiplexer (19). The control signal (22) determines which receiver output (17), or (18) will be routed through the multiplexer (19) to the output (20). When both optical power monitoring lines (15, 16) indicates that the communication link operates without a failure, the controller selects one receiver output (17) or (18) as the primary output, to be routed to the transceiver's output (20). If the optical power monitoring line (15) or (16), associated with the receiver which is selected as primary, indicates a loss of optical power at the primary receiver (11, or 12), the controller (13) automatically switches the multiplexer (19), to route data from the alternate secondary receiver to the transceiver's output (20). Upon restoration of optical power to the alternate receiver, the controller may switch back to its primary setup, switch over in case of failure in the primary channel, or switch to either receiver upon external command.

In certain cases a receiver (11, 12) within a transceiver module may fail to operate correctly. In such cases, the power monitoring signals (15, 16) may indicate proper optical power level, even when a receiver fails to output data (17, 18). In the embodiment shown in FIG. 7, the controller (13) receives the power monitoring signals (15, 16), along with samples of the data outputs (17, 18) of the receivers (11, 12). The controller determines that a receiver is operating correctly if both, the power monitoring signal (15, or 16), and the data output (17, or 18) associated with one receiver, simultaneously indicate proper operating conditions. If the optical power monitoring signal (15, or 16), associated with one receiver, indicates sufficient optical power reception, and the data output (17, or 18) of that receiver indicates no valid or recoverable data, that receiver is termed as secondary receiver, and the controller (13), switches the multiplexer (19) over to the other receiver, which is now termed the primary receiver.

The fiber-optic transmitter (11) generates optical power to be transmitted via a fiber-optic cable. Typically fiber-optic transmitters are fitted with means to control bias and other operation parameters necessary for proper operation of such transmitters. Fiber-optic transmitters are also typically fitted with means to monitor the transmitter optical power levels. In the embodiments shown in FIGS. 6, and 7, the optical power output level monitoring signal (30) is sent from the transmitter (11), to the controller (13). The controller on the other hand controls the operating parameters of the transmitter via the control line (23), and modifies these parameters in response to variations in the optical output power as indicated by the monitoring line (30). Due to its role as supervisor of the transmitter, the controller (13) is able to determine the normal operation conditions for the transmitter (11), and detect when the transmitter fails.

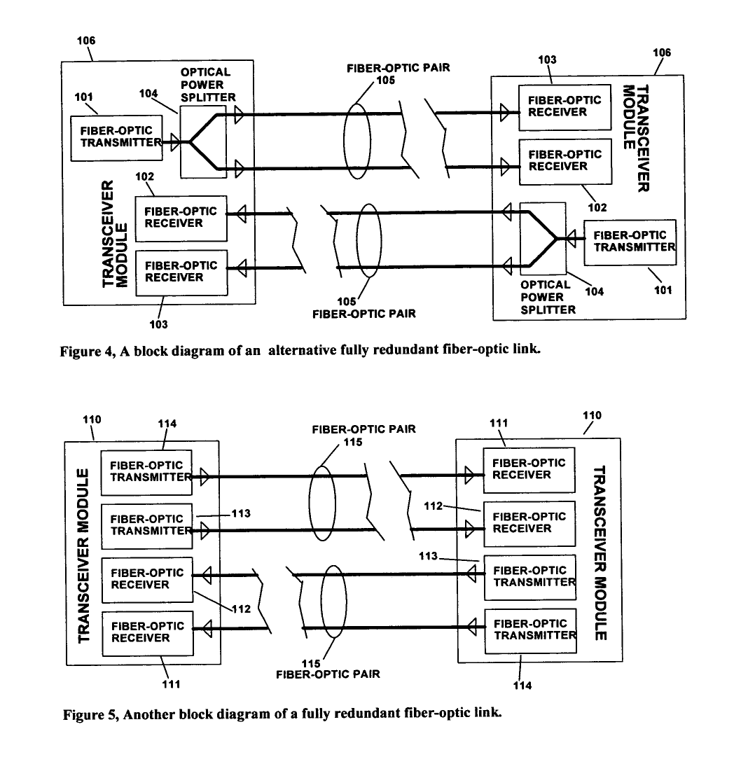

FIG. 4, shows an alternative approach that yields the same results. The embodiment shown in FIG. 4 includes the same components as the embodiment shown in FIG. 3, except that in the case shown in FIG. 4, the optical power splitter (104), is moved inside the transceiver module (106).

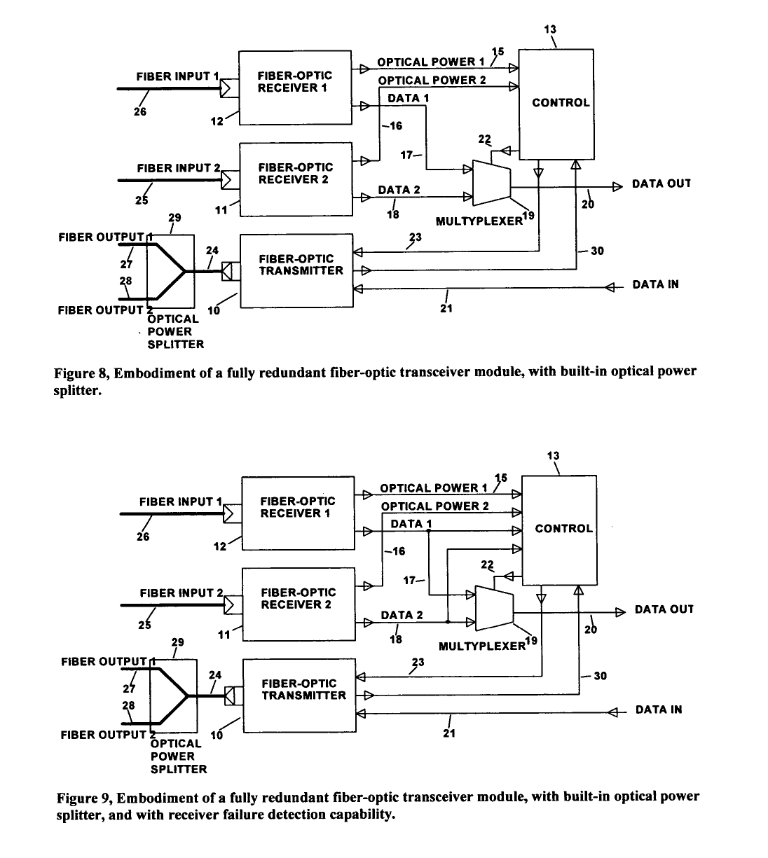

FIGS. 8, and 9, show the embodiment of the fiber-optic transceiver shown in FIG. 4. These embodiments are similar in design and function to the embodiments shown in FIGS. 6, and 7, except for the optical power splitter (29) which, in the embodiments shown in FIGS. 8, and 9, is placed inside the transceiver module. The optical power splitter (29), receives optical power from the fiber-optic transmitter (11), and splits it evenly, in terms of optical power, between to fiber-optic cables (27, 28).

FIG. 5, shows another approach for a fully redundant link, wherein each transceiver module (110) is comprised of two fiber-optic transmitters (111, 112), and two fiber-optic receivers (113, 114), providing two complete communication paths, for full redundancy.

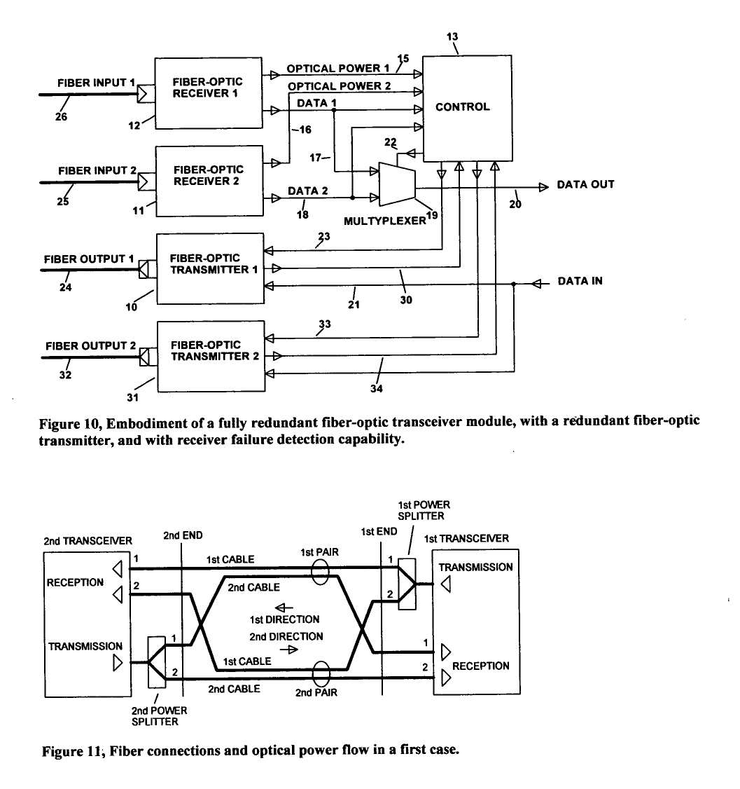

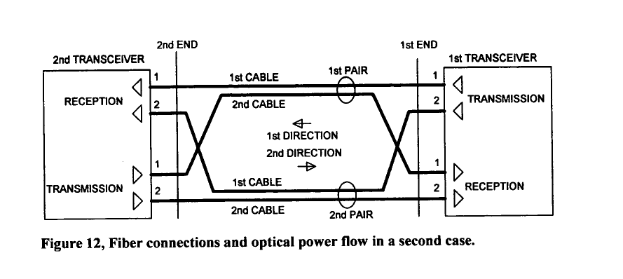

FIG. 10, shows the embodiment of the transceiver (106) shown in FIG. 5. In this embodiment, the two receivers (11, and 12), and the circuitry connected to these receivers, are identical in all respects, to the parallel functions in FIGS. 7, and 9. In this embodiment two transmitters are used (10, and 31). Both transmitters are identical to each other, and both are controlled by the controller (13) via the control lines (23, and 33) respectively. The data input to the transceiver (21) is connected in parallel to both transmitters (10, and 31), enabling both transmitters to simultaneously transmit the same data. Since there is no need for the two transmitters to transmit simultaneously, one transmitter may be arbitrarily declared as the primary transmitter. The primary transmitter is always active, while the other transmitter is declared as secondary, may be active as well, or on standby, to be activated only in the case of a failure in the primary transmitter, or in the primary fiber connection. Controller (13) determines which transmitters are turned ON at any time.

While the invention has been described in detail in connection with certain preferred embodiments known at the time, it should be readily understood that the methods and devices of the invention are not limited to the disclosed exemplary embodiments. Rather, the present devices, apparatus and methods can be modified to incorporate any number of variations, alterations, substitutions or equivalent arrangements not heretofore specifically described, but which are commensurate with the spirit and scope of the invention.

1. A fiber-optic transceiver module comprising
A fiber-optic transmitter;
A first fiber-optic receiver;
A second fiber-optic receiver;
A digital multiplexer;
A controller to control the multiplexer.

2. A fiber-optic transmitter as in claim 1, generating a modulated optical power in response to a digital input.

3. A first fiber-optic receiver as in claim 1, generating a digital output in response to modulated optical power at its optical input.

4. A second fiber-optic receiver as in claim 1, generating a digital output in response to modulated optical power at its optical input.

5. A digital multiplexer as in claim 1, to select and route data from either the first fiber-optic receiver, or from the second fiber-optic receiver, to the transceiver's output.

6. A controller as in claim 1, to control the multiplexer.

7. An optical power splitter, not inside the fiber-optic transceiver module, to receive optical power from the transmitter as in claim 1, and produce two reduced power copies of the received optical power, and transfer these copies of the input optical power to two fiber-optic cables.

8. A fiber-optic transceiver module comprising
A fiber-optic transmitter;
A fiber-optic power splitter
A first fiber-optic receiver;
A second fiber-optic receiver;
A digital multiplexer;
A controller to control the multiplexer.

9. A fiber-optic transmitter as in claim 8, generating a modulated optical power in response to a digital input.

10. A fiber-optic receiver as in claim 8, generating a digital output in response to modulated optical power at its optical input.

11. A second fiber-optic receiver as in claim 8, generating a digital output in response to modulated optical power at its optical input.

12. A digital multiplexer as in claim 8, to select and route data from either the first fiber-optic receiver, or from the second fiber-optic receiver, to the transceiver's output

13. A controller as in claim 8, to control the multiplexer.

14. An optical power splitter to receive optical power from the transmitter as in claim 8, and to produce two reduced power copies of the received optical power, and to transfer these copies of the input optical power to two fiber-optic ports of the transceiver module.

15. A fiber-optic transceiver module comprising
A first fiber-optic transmitter;
A second fiber-optic transmitter;
A first fiber-optic receiver;
A second fiber-optic receiver;
A digital multiplexer;
A controller to control the multiplexer.

16. A first fiber-optic transmitter as in claim 15, generating a modulated optical power in response to a digital input.

17. A second fiber-optic transmitter as in claim 15, generating a modulated optical power in response to a digital input, wherein the digital input to the second transmitter is identical to the digital input to the first fiber-optic transmitter, and further wherein both the first and the second fiber-optic transmitters may transmit simultaneously.

18. A first fiber-optic receiver as in claim 15, generating a digital output in response to modulated optical power at its optical input.

19. A second fiber-optic receiver as in claim 15, generating a digital output in response to modulated optical power at its optical input.

20. A digital multiplexer as in claim 15, to select and route data from either the first fiber-optic receiver or from the second fiber-optic receiver to the transceiver's output.

21. A controller as in claim 15, to control the multiplexer.

22. A fully redundant fiber-optic communication link comprising of
A first fiber-optic transceiver module as in claim 1;
A second fiber-optic transceiver module as in claim 1;
A first pair of fiber-optic cables;
A second pair of fiber-optic cables;
A first optical power splitter as in claim 7;
A second optical power splitter as in claim 7.

23. A fiber-optic transceiver as in claim 22 comprising of
A fiber-optic transmission port;
A first fiber-optic reception port;
A second fiber-optic reception port;
A single digital data input port;
A single digital data output port.

24. A first pair of fiber-optic cables as in claim 22, wherein the first fiber-optic cable of the first pair conveys optical power in a first direction into the first receiving port of the second fiber-optic transceiver, and wherein the second fiber-optic cable of the first pair conveys optical power in a second direction into the first receiving port of the first fiber-optic transceiver.

25. A second pair of fiber-optic cables as in claim 22, wherein the first fiber-optic cable of the second pair conveys optical power in a first direction into the second receiving port of the second fiber-optic transceiver, and wherein the second fiber-optic cable of the second pair conveys optical power in a second direction into the second receiving port of the first fiber-optic transceiver.

26. A first optical power splitter as in claim 22, wherein an input port of the optical power splitter connects via a fiber-optic cable to the optical transmission port of the first fiber-optic transceiver, and wherein the first output port of the first optical power splitter connects to the first fiber-optic cable of the first pair of cables, and further wherein the second output port of the first optical power splitter connects to the first fiber-optic cable of the second pair of fiber-optic cables.

27. A second optical power splitter as in claim 22, wherein an input port of the optical power splitter connect via a fiber-optic cable to the optical transmission port of the second fiber-optic transceiver, and wherein the first output port of the second optical power splitter connects to the second fiber-optic cable of the first pair of cables, and further wherein the second output port of the second optical power splitter connects to the second fiber-optic cable of the second pair of fiber-optic cables.

28. A fully redundant fiber-optic communication link comprising of
A first fiber-optic transceiver module as in claim 8;
A second fiber-optic transceiver module as in claim 8;
A first pair of fiber-optic cables;
A second pair of fiber-optic cables;
A first optical power splitter as in claim 7;
A second optical power splitter as in claim 7.

29. A fiber-optic transceiver as in claim 28 comprising of
A first fiber-optic transmission port;
A second fiber-optic transmission port;
A first fiber-optic reception port;
A second fiber-optic reception port;
A single digital data input port;
A single digital data output port.

30. A first pair of fiber-optic cables as in claim 28, wherein the first end of first fiber-optic cable of the first pair connects to the first optical transmission port of the first fiber-optic transceiver, and wherein the second end of the first fiber-optic cable of the first pair of fiber-optic cables connects to the first optical reception port of the second fiber-optic transceiver.

31. A first pair of fiber-optic cables as in claim 28, wherein the second end of the second fiber-optic cable of the first pair connects to the first optical transmission port of the second fiber-optic transceiver, and wherein the first end of the second fiber-optic cable of the first pair of fiber-optic cables connects to the first optical reception port of the first fiber-optic transceiver.

32. A second pair of fiber-optic cables as in claim 28, wherein the first end of the first fiber-optic cable of the second pair connects to the second optical transmission port of the first fiber-optic transceiver, and wherein the second end of the first fiber-optic cable of the second pair of fiber-optic cables connects to the second optical reception port of the second fiber-optic transceiver.

33. A second pair of fiber-optic cables as in claim 28, wherein the second end of the second fiber-optic cable of the second pair connects to the second optical transmission port of the second fiber-optic transceiver, and wherein the first end of the second fiber-optic cable of the second pair of fiber-optic cables connects to the second optical reception port of the first fiber-optic transceiver.

34. A fully redundant fiber-optic communication link comprising of
A first fiber-optic transceiver module as in claim 15;
A second fiber-optic transceiver module as in claim 15;
A first pair of fiber-optic cables;
A second pair of fiber-optic cables.

35. A fiber-optic transceiver as in claim 34 comprising of
A first fiber-optic transmission port;
A second fiber-optic transmission port;
A first fiber-optic reception port;
A second fiber-optic reception port;
A single digital data input port;
A single digital data output port.

36. A first pair of fiber-optic cables as in claim 34, wherein the first end of first fiber-optic cable of the first pair connects to the first optical transmission port of the firs fiber-optic transceiver, and wherein the second end of the first fiber-optic cable of the first pair of fiber-optic cables connects to the first optical reception port of the second fiber-optic transceiver.

37. A first pair of fiber-optic cables as in claim 34, wherein the second end of second fiber-optic cable of the first pair connects to the first optical transmission port of the second fiber-optic transceiver, and wherein the first end of the second fiber-optic cable of the first pair of fiber-optic cables connects to the first optical reception port of the first fiber-optic transceiver.

38. A second pair of fiber-optic cables as in claim 34, wherein the first end of the first fiber-optic cable of the second pair connects to the second optical transmission port of the first fiber-optic transceiver, and wherein the second end of the first fiber-optic cable of the second pair of fiber-optic cables connects to the second optical reception port of the second fiber-optic transceiver.

39. A second pair of fiber-optic cables as in claim 34, wherein the second end of the second fiber-optic cable of the second pair connects to the second optical transmission port of the second fiber-optic transceiver, and wherein the first end of the second fiber-optic cable of the second pair of fiber-optic cables connects to the second optical reception port of the first fiber-optic transceiver.

40. A fully redundant fiber-optic communication link wherein the failure of a transceiver, or a repeater or any other intermediary component on one of the two redundant communication channels does not cause interruption of communication, allowing uninterrupted communication through the alternate communication channel.

41. A fully redundant fiber-optic communication link as in claim 40, wherein the decisions on switching communication channels in case of failure in one communication channel, or switching back upon recovery of the failed channel, can be controlled automatically or by administrative control.

42. A fully redundant fiber-optic communication link as in claim 40, wherein the selection of the primary communication channel can be done by the communication network administrator.
